(19) United States
(12) Patent Application Publication
(10) Pub. No.: US 2007/0251043 A1
(43) Pub. Date: Nov. 1, 2007

(54) Window Wiping Device, Especially for a Motor Vehicle

(75) Inventor: Andreas Benner, Baden-Baden (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Suttgart (DE)

(21) Appl. No.: 10/577,964

(22) PCT Filed: Sep. 10, 2004
(86) PCT No.: PCT/DE04/02013

§ 371 Date: Mar. 27, 2007

(30) Foreign Application Priority Data
Nov. 7, 2003 (DE) 103 52 468.1

(51) Int. Cl. B60S 1/18

(52) U.S. Cl. 15/250.001

(57) ABSTRACT

A windshield wiper device (10) is proposed, in particular for a motor vehicle, comprising at least: one wiper shaft (28) that is provided with a recess (46); a means (32) for partially accommodating the wiper shaft (28), a free end (40) of which protrudes from the accommodating means (32); an essentially annular locking element (48) that is provided with an interruption (54) along the circumference thereof, is arranged in the recess (46), and is used for at least partially locking the wiper shaft (28) in an axial direction inside the accommodating means (32); wherein the locking element (48) has essentially a rectangular structure in cross section; and the recess (46) encompasses at least one slope (56) in the axial direction of the wiper shaft (28), along which the locking element (48) can glide when a predetermined, essentially axial force (F) is applied to the wiper shaft (28).

### PRIOR ART

The invention relates to a windshield wiper device, in particular for a motor vehicle in accordance with the species of the independent claim.

Numerous windshield wiper devices, which have a wiper shaft with a recess positioned in a wiper position¹ as accommodating means, are already known, for example from DE 196 18 873. The wiper shaft in this case features a free end that projects from the accommodating means. To axially lock the wiper shaft a locking element is provided in this case, which is embodied as a C-shaped ring, which is arranged coaxially on the wiper shaft and tapers or enlarges in an axial direction at an angle towards the accommodating means. If a force is applied to the free end of the wiper shaft, the C-shaped ring is bent open, whereby the wiper shaft can yield and shift in the direction of the accommodating means. In this way, the free end of the wiper shaft on which the wiper arm is fastened can move in the direction of the body of the motor vehicle in the case of an impact of a pedestrian on the wiper arm or the wiper shafts, thereby reducing the risk of injury to the pedestrian.
Translator's note: This may be a typographical error, in which “Wischerlage” (=wiper position) was written instead of “Wischerlager” (=wiper bearing).

However, this sort of solution is relatively expensive, cost-intensive as well as problematic in terms of manufacturing the locking element.

A wiper shaft with a cross-sectional V-shaped recess, into which a C-shaped ring with an essentially circular cross section is inserted to lock the wiper shaft, is known from DE 198 51 881 C2.

What is problematic in this case is that the axial force that is required to push in the wiper shaft into the accommodating means is too undefined and, as a result, effective pedestrian impact protection can only be realized in an inadequate manner.

### ADVANTAGES OF THE INVENTION

The windshield wiper device in accordance with the invention with the features of the main claim has the advantage that a C-shaped locking element, which is therefore essentially embodied annularly and provided with an interruption along the circumference thereof, which essentially has a rectangular structure in cross section, offers a simple and cost-effective solution in which the predetermined force can also be set easily. The locking element can therefore glide on the slope of the recess when the predetermined force is applied to the wiper shaft so that optimum pedestrian impact protection is realized.

Advantageous developments and improvements of the features disclosed in the main claim are yielded by the measures listed in the subordinate claims.

It is especially advantageous if the slope is embodied to be circumferential and has an angle between 25 and 75 degrees with respect to the longitudinal axis of the wiper shaft, particularly between 35 and 55, preferably between 40 and 50 degrees. This guarantees secure gliding of the locking element on the slope of the recess of the wiper shaft and the wiper shaft is easy to manufacture.

It is especially advantageous in this case if the angle of the slope is approximately 45 degrees. Ideally, the predetermined force is between 800 and 3000 N, in particular between 1000 and 2000 N, preferably set at approximately 1500 N. These are typically the forces with which a pedestrian impacts the wiper shafts of the windshield wiper device in a crash so that significant injuries to the pedestrian can be avoided.

In a simple design, the force is determined by the angle of the slope with respect to the longitudinal axis of the wiper shaft.

The recess advantageously features two areas in cross section and namely a first glide area, which is formed by the slope, and a second seat area, which is flat or slightly sloped, and in which the locking element is arranged in the normal operating position.

It is especially advantageous in this case if the recess has three areas in cross section, and namely yet another sloped area in addition to the glide area and the seat area so that the locking element can be inserted into the recess in a simple manner, thereby facilitating assembly.

It is especially cost-effective if the locking element is embodied as a stamped part, particularly made of sheet metal, or as a plastic part.

In order to keep the wear of the accommodating means to a minimum, the locking element rests advantageously on a stop disk, which is attached coaxially to the wiper shaft on the accommodating means.

Ideally, the stop disk is supported on the accommodating means.

### DRAWINGS

One exemplary embodiment of the invention is depicted in the drawings and explained in greater detail in the following description. The drawings show:

FIG. 1 A schematic depiction of a windshield wiper device in accordance with the invention

FIG. 2 A perspective representation of the wiper bearing with a wiper shaft of a windshield wiper device in accordance with the invention

FIG. 3 A representation in accordance with the invention of the free end of the wiper shaft in detail

FIG. 4a The wiper shaft of a windshield wiper device in accordance with the invention in detail

FIG. 4b A top view of a locking element of a windshield wiper device in accordance with the invention

FIG. 5 A schematic cross-sectional depiction of the recess in the wiper shaft

### DESCRIPTION OF THE EXEMPLARY EMBODIMENT

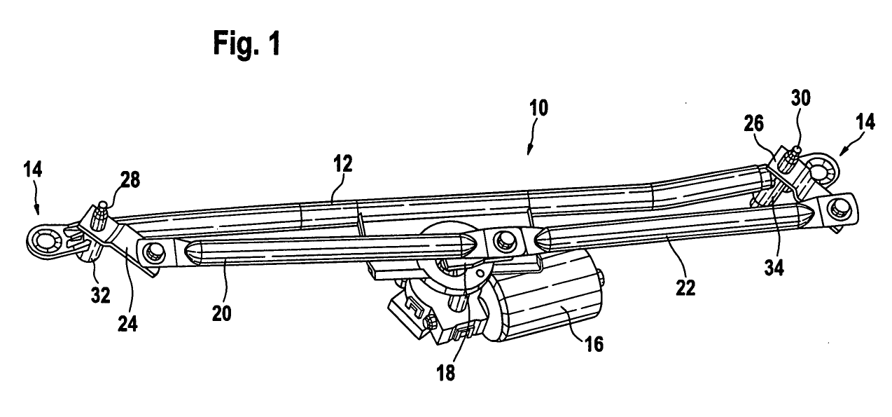

FIG. 1 shows perspective representation of a windshield wiper device 10 in accordance with the invention.

This device comprises a support tube 12 having two ends, on each of which a wiper bearing 14 is fastened. Attached in the center of the longitudinal extension of the support tube 12 is a wiper motor 16 as a drive unit, which puts a crank 18 into either a back and forth movement or a rotating movement. The free end of the crank 18 is connected to two thrust rods 20, 22, which move driving cranks 24, 26, which are connected in a rotationally secured manner to wiper shafts 28, 30, which they drive. The wiper shafts 28, 30 are rotatably mounted in the accommodating means 32, 34 of the wiper bearing 14 and in an assembled state are connected to the wiper arms of the motor vehicle in a rotationally secured manner and wiper blades can be fastened to the free ends of said wiper arms. Wiper arms and wiper blades are not shown here for the sake of clarity.

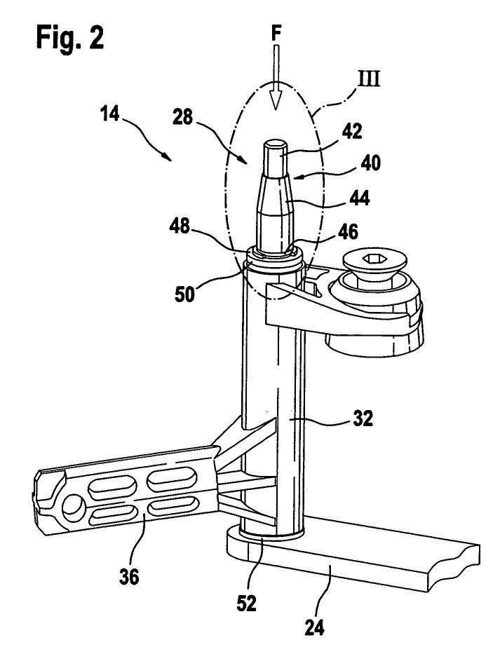

FIG. 2 shows a wiper bearing 14 of a windshield wiper device 10 in accordance with the invention in detail.

The wiper bearing 14 comprises essentially the accommodating means 32 embodied as a molded tube, on which a fastening piece 36 extends radially outwardly, which serves to fasten the wiper bearing to the support tube 12. Extending in the same way radially outwardly from the accommodating means 32, but offset by approximately 180 degrees, is a fastening plate 38, which serves to fasten the wiper bearing 14 and therefore the entire windshield wiper device 10 to the motor vehicle. The wiper bearing 14 is manufactured as a one-part piece of plastic in an injection molding process. Naturally, the wiper bearing 14 can also be manufactured of metal, for example aluminum or zinc in a die-casting method.

The wiper shaft 28 is inserted into the molded tube 32. The wiper shaft is longer than the longitudinal extension of the molded tube 32 and projects at one end essentially beyond the molded tube 32. This end is designated in the following as the free end 40. In an assembled state, the wiper arm is connected to the wiper shaft 28 on the free end 40 in a rotationally secured manner. The free end has a thread 42 as well as a cone 44 for this purpose. The driving crank 24 is connected in a rotationally secured manner to the wiper shaft 28 on the end of the wiper shaft 28 that is opposite from the free end 40 so that the shaft can be put into a back and forth movement via the driving crank 24.

The wiper shaft 28 also features a radial circumferential recess 46 into which a C-shaped securing ring that is rectangular in cross section is inserted as a locking element 48. The locking element 48 and the recess 46 are arranged in such a way with respect to the longitudinal extension of the wiper shaft 28 that the locking element 48 rests on a stop disk 50 in operation, which in turn is directly supported on the molded tube 32, i.e., on the accommodating means. Another stop disk 52 is arranged in the same manner between the driving crank 24 and the molded tube 32.

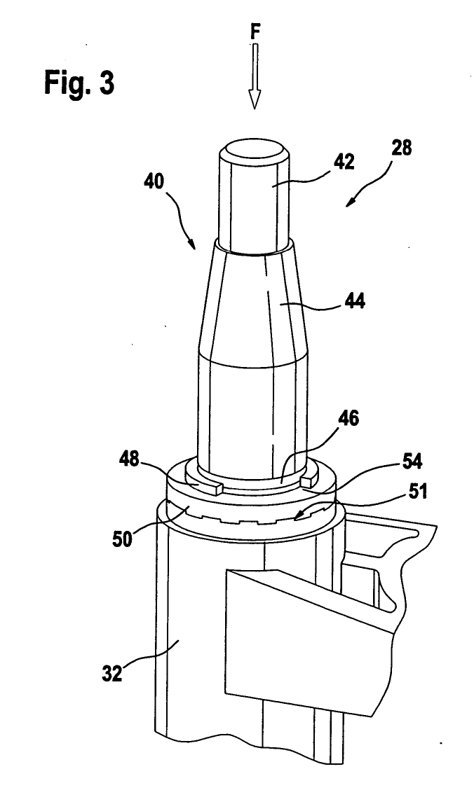

FIG. 3 depicts in detail the free end of the wiper shaft 28 with the upper section of the molded tube 32.

The molded tube 32 serves as a bearing to the wiper shaft 28. Typically, bearing bushes are inserted for this purpose into the molded tube 32. Arranged in the area of the longitudinal extension of the wiper shaft 28, where it exits the molded tube 32, is the recess 46 that is tub-shaped in cross section. The locking element 48, which is embodied as a ring with an interruption 54, i.e., C-shaped, sits in this recess. This locking element 48 has an essentially rectangular form in cross section and rests on the stop disk 50. The stop disk 50 in turn rests directly on the top surface 51 of the hollow cylindrical molded tube 32.

If a force F is now applied, for example due to the impact of a pedestrian on the wiper shaft 28, in the axial direction on said wiper shaft, the C-shaped locking element is bent open due to the tub-shaped formation of the recess 46, whereby the free end 40 of the wiper shaft 28 can displace in the direction of the molded tube 32 as accommodating means. In this way, injuries to the pedestrian are avoided during an impact.

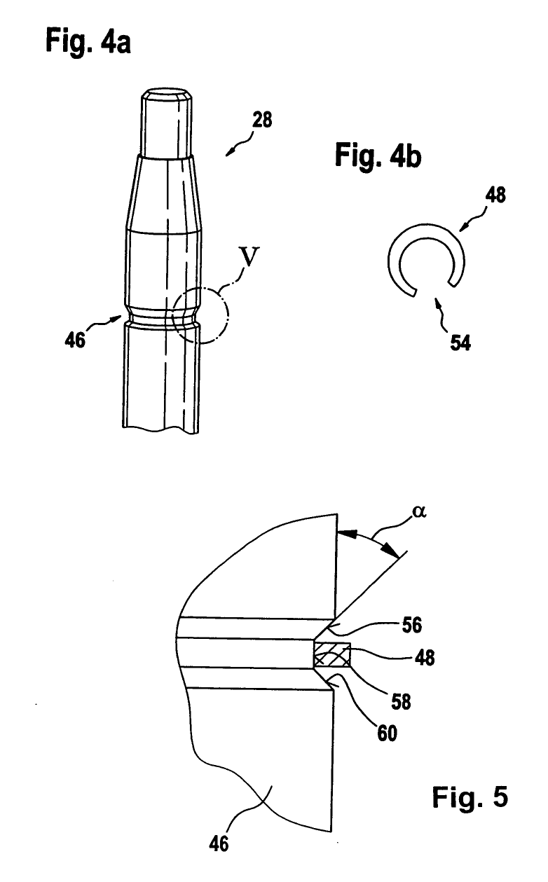

FIG. 4a again shows a detailed depiction of the wiper shaft 28 of a windshield wiper device 10 in accordance with the invention with the recess 46. The recess 46 is arranged circumferentially and features an essentially tub-shaped cross-sectional structure. Of course, it is also possible to provide a radial interruption in the recess 46, for example in order to prevent the locking element 48 from twisting.

FIG. 4b shows a top view of a locking element 48. The locking element 48 is stamped of sheet metal and has an essentially annular structure with the interruption 54 so that a C-shaped element is produced, which can be inserted simply into the recess 46 of the wiper shaft. The locking element 48 is rectangular or square in cross section. This type of locking element 48 can be stamped from sheet metal in a simple manner.

FIG. 5 depicts the recess 46 and the locking element 48 in detail in cross section. The recess 46 is embodied to be tub-shaped and therefore has essentially three areas 56, 58, 60. The first glide area 56 formed by a slope 56, which is inclined by angle alpha by approximately 45 degrees vis-à-vis the longitudinal axis of the wiper shaft 28. Directly adjacent to this glide area 56 is a slightly sloped seat area 58, which is inclined vis-à-vis the longitudinal axis of the wiper shaft 28 by an angle of less than 10 degrees in the opposite direction of the glide area 56. The locking element 48 is held on the glide area 56, because of this seat area 58, which naturally can also be embodied to be flat. A sloped area 60 is adjacent to the seat area 58 as the third area, which, just like the glide area 56, is inclined at an angle of approximately 45 degrees with respect to the longitudinal axis of the wiper shaft 28, however, in the opposite direction thereby producing the tub-shaped form of the recess 46 in cross section.

The locking element 48 is arranged in the seat area 58 of the recess 46 during the normal wiping operation of the windshield wiper device 10. Now if an essentially axial force F is applied to the free end 40 of the wiper shaft 28, the locking element 48 glides along the slope of the glide area 56 and is thereby bent open. To do this, the frictional force as well as the force to bend open the locking element 48 must be applied, whereby energy from the impact that is causing force F is absorbed. If the locking element 48 has completely traversed the glide area 56, it glides along the outer surface of the cylindrical wiper shaft 28, whereby energy is further absorbed because of the friction between the wiper shaft 28 and the locking element 48. The wiper shaft 28 disappears in the process more and more into the accommodating means 32 of the wiper bearing 14.

The force F that is required to allow the locking element to glide on the slope of the glide area 56, can be adjusted in a simple manner by angle alpha. In addition, an auxiliary shape element, for example a radius, can be provided between the seat area 58 and the glide area 56 so that the locking element 48 does not begin to glide on slope 56 until it overcomes an initial force AF. The predetermined force F can naturally also be set via a suitable selection of the materials and/or the surface quality of the wiper shaft 28 and the locking element 48.

Of course, the embodiment in accordance with the invention can also be used with another windshield wiper device 10. The embodiment in accordance with the invention permits an effective and cost-effective pedestrian impact protection to be realized particularly in the case of windshield wiper devices with a wiper direct drive that dispense with a thrust rod gear.

1. Windshield wiper device (10), in particular for a motor vehicle, comprising at least:
one wiper shaft (28) that is provided with a recess (46) and
a means (32) for partially accommodating the wiper shaft (28), a free end (40) of which protrudes from the accommodating means (32) and
an essentially annular locking element (48) that is provided with an interruption (54) along the circumference thereof, is arranged in the recess (46), and is used for at least partially locking the wiper shaft (28) in an axial direction inside the accommodating means (32), characterized in that
the locking element (48) has essentially a rectangular structure in cross section,
that the recess (46) encompasses at least one slope (56) in the axial direction of the wiper shaft (28), along which the locking element (48) can glide when a predetermined, essentially axial force (F) is applied to the wiper shaft (28).

2. Windshield wiper device (10) according to claim 1, characterized in that the slope (56) is embodied to be circumferential and has an angle (alpha) between 25 and 75 degrees with respect to the longitudinal axis of the wiper shaft (28), particularly between 35 and 55, preferably between 40 and 50 degrees.

3. Windshield wiper device (10) according to claim 2, characterized in that the slope (56) has an angle (alpha) of approximately 45 degrees.

4. Windshield wiper device (10) according to claim 1, characterized in that the predetermined force (F) is between 800 and 3000 N, in particular between 1000 and 2000 N, preferably approximately 1500 N.

5. Windshield wiper device (10) according to claim 4, characterized in that the angle of the slope (56) with respect to the longitudinal axis of the wiper shaft (28) is determined as a function of the force (F).

6. Windshield wiper device (10) according to claim 1, characterized in that the recess (46) features at least two areas (56, 58) in cross section and namely a first glide area (56) formed by the slope (56) and a second essentially flat or slightly sloped seat area (58) adjacent to the glide area (56).

7. Windshield wiper device (10) according to claim 6, characterized in that the recess (46) has three areas (56, 58, 60) in cross section and namely a first glide area (56), a second seat area (58) and a third sloped area (60) that is adjacent to the seat area (58) on the side of the accommodating means (32) and is essentially embodied like the glide area (56) so that the recess (46) essentially has a tub-shaped structure in cross section.

8. Windshield wiper device (10) according to claim 1, characterized in that the locking element (48) is embodied as a stamped part or as a plastic part.

9. Windshield wiper device (10) according to claim 1, characterized in that the locking element (48) is resting on a stop disk (50).

10. Windshield wiper device (10) according to claim 9, characterized in that the stop disk (50) is supported on the accommodating means (32).

11. Windshield wiper device (10) according to claim 2, characterized in that the predetermined force (F) is between 800 and 3000 N, in particular between 1000 and 2000 N, preferably approximately 1500 N.

12. Windshield wiper device (10) according to claim 3, characterized in that the predetermined force (F) is between 800 and 3000 N, in particular between 1000 and 2000 N, preferably approximately 1500 N.

13. Windshield wiper device (10) according to claim 5, characterized in that the recess (46) features at least two areas (56, 58) in cross section and namely a first glide area (56) formed by the slope (56) and a second essentially flat or slightly sloped seat area (58) adjacent to the glide area (56).

14. Windshield wiper device (10) according to claim 13, characterized in that the recess (46) has three areas (56, 58, 60) in cross section and namely a first glide area (56), a second seat area (58) and a third sloped area (60) that is adjacent to the seat area (58) on the side of the accommodating means (32) and is essentially embodied like the glide area (56) so that the recess (46) essentially has a tub-shaped structure in cross section.

15. Windshield wiper device (10) according to claim 14, characterized in that the locking element (48) is embodied as a stamped part or as a plastic part.

16. Windshield wiper device (10) according to claim 15, characterized in that the locking element (48) is resting on a stop disk (50).

17. Windshield wiper device (10) according to claim 16, characterized in that the stop disk (50) is supported on the accommodating means (32).
